(19) United States
(12) Patent Application Publication
(10) Pub. No.: US 2025/0374196 A1
(43) Pub. Date: Dec. 4, 2025

(54) PROCESSING METHOD AND APPARATUS OF RADIO RESOURCE MANAGEMENT MEASUREMENT, AND TERMINAL

(71) Applicant: VIVO MOBILE COMMUNICATION CO., LTD., Guangdong (CN)

(72) Inventors: Kai WU, Guangdong (CN); Xueming Pan, Guangdong (CN)

(73) Assignee: VIVO MOBILE COMMUNICATION CO., LTD., Guangdong (CN)

(21) Appl. No.: 19/298,707

(22) Filed: Aug. 13, 2025

Related U.S. Application Data
(63) Continuation of application No. PCT/CN2024/076195, filed on Feb. 6, 2024.

(30) Foreign Application Priority Data
Feb. 13, 2023 (CN) 202310106655.6

(51) Int. Cl. H04W 52/02; H04W 24/08

(52) U.S. Cl. CPC H04W 52/0248; H04W 24/08

(57) ABSTRACT

This application discloses a processing method and apparatus of radio resource management measurement, and a terminal. The method includes: determining, by a terminal, a measurement mode based on a target measurement value; and performing, by the terminal, radio resource management (RRM) measurement based on the measurement mode, where the target measurement value is determined based on at least one of a measurement value obtained by using a low power wake up radio (LP WUR) to perform measurement and a measurement value obtained by using a main radio (MR) to perform measurement, and the measurement mode includes any one of the following: using the LP WUR for RRM measurement, and/or using the MR for RRM measurement based on a first periodicity; and using the MR for RRM measurement based on a second periodicity, where a length of the first periodicity is greater than a length of the second periodicity.

### CROSS-REFERENCE TO RELATED APPLICATIONS

This application is a continuation application of PCT International Application No. PCT/CN2024/076195 filed on Feb. 6, 2024, which claims priority to Chinese Patent Application No. 202310106655.6, filed on Feb. 13, 2023 in China, which is incorporated herein by reference in its entirety.

### TECHNICAL FIELD

This application belongs to the field of communication technologies, and in particular, to a processing method and apparatus of radio resource management measurement, and a terminal.

### BACKGROUND

With the development of communication technology, a low power wake up signal (LP-WUS) is received by introducing a low power wake up radio/receiver (LP-WUR) in a mobile communication terminal, so that a main communication module is in an off or sleep state, and power consumption of the terminal can be effectively reduced. At present, the terminal in an idle state or an inactive state usually enables the main communication module periodically for radio resource management (RRM) measurement, which may result in larger power consumption of the terminal for RRM measurement.

### SUMMARY

According to a first aspect, a processing method of radio resource management measurement is provided, including:
determining, by a terminal, a measurement mode based on a target measurement value; and
performing, by the terminal, radio resource management (RRM) measurement based on the measurement mode, where
the target measurement value is determined based on at least one of a measurement value obtained by using a low power wake up radio (LP WUR) to perform measurement and a measurement value obtained by using a main radio (MR) to perform measurement, and the measurement mode includes any one of the following:
using the LP WUR for RRM measurement, and/or using the MR for RRM measurement based on a first periodicity; and
using the MR for RRM measurement based on a second periodicity, where
a length of the first periodicity is greater than a length of the second periodicity.

According to a second aspect, a processing apparatus of radio resource management measurement is provided, including:
a determining module, configured to determine a measurement mode based on a target measurement value; and
an execution module, configured to perform radio resource management (RRM) measurement based on the measurement mode, where
the target measurement value is determined based on at least one of a measurement value obtained by using a low power wake up radio (LP WUR) to perform measurement and a measurement value obtained by using a main radio (MR) to perform measurement, and the measurement mode includes any one of the following:
using the LP WUR for RRM measurement, and/or using the MR for RRM measurement based on a first periodicity; and
using the MR for RRM measurement based on a second periodicity, where
a length of the first periodicity is greater than a length of the second periodicity.

According to a third aspect, a terminal is provided. The terminal includes a processor and a memory, the memory stores a program or an instruction that can be run on the processor, and the program or the instruction is executed by the processor to implement the steps of the method according to the first aspect.

According to a fourth aspect, a terminal is provided, including a processor and a communication interface, where the processor is configured to determine a measurement mode based on a target measurement value; and
the communication interface is configured to perform radio resource management (RRM) measurement based on the measurement mode, where
the target measurement value is determined based on at least one of a measurement value obtained by using a low power wake up radio (LP WUR) to perform measurement and a measurement value obtained by using a main radio (MR) to perform measurement, and the measurement mode includes any one of the following:
using the LP WUR for RRM measurement, and/or using the MR for RRM measurement based on a first periodicity; and
using the MR for RRM measurement based on a second periodicity, where
a length of the first periodicity is greater than a length of the second periodicity.

According to a fifth aspect, a readable storage medium is provided, where the readable storage medium stores a program or an instruction, and when the program or the instruction is executed by a processor, the steps of the method according to the first aspect are implemented.

According to a sixth aspect, a chip is provided. The chip includes a processor and a communication interface, the communication interface is coupled to the processor, and the processor is configured to run a program or an instruction to implement the steps of the method according to the first aspect.

According to a seventh aspect, a computer program/program product is provided. The computer program/program product is stored in a storage medium, and the computer program/program product is executed by at least one processor to implement the steps of the method according to the first aspect.

### BRIEF DESCRIPTION OF DRAWINGS

FIG. 1 is a schematic diagram of a network structure to which this application is applicable;

FIG. 2 is a schematic flowchart of a processing method of radio resource management measurement according to an embodiment of this application;

FIG. 3 is a schematic diagram of a structure of a processing apparatus of radio resource management measurement according to an embodiment of this application;

FIG. 4 is a schematic diagram of a structure of a communication device according to an embodiment of this application; and

FIG. 5 is a schematic diagram of a structure of a terminal according to an embodiment of this application.

### DESCRIPTION OF EMBODIMENTS

The following clearly describes technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in the specification and claims of this application are used to distinguish between similar objects instead of describing a specific order or sequence. It should be understood that the terms used in this way are interchangeable in appropriate circumstances such that the embodiments of this application can be implemented in other orders than the order illustrated or described herein. In addition, objects distinguished by “first” and “second” are generally of a same type, and the number of objects is not limited, for example, there may be one or more first objects. In addition, in this specification and the claims, “or” represents at least one of connected objects. For example, “A or B” covers three solutions, namely, solution 1: including A and not including B; solution 2: including B and not including A; and solution 3: including A and B. A character “/” generally indicates an “or” relationship between the associated objects.

The term “indication” in the specification and claims of this application may be either an explicit indication or an implicit indication. The explicit indication can be understood as that a sender clearly informs a receiver of an operation required to be performed or a request result in a sent indication; and the implicit indication can be understood as that the receiver makes a determination based on an indication sent by the sender, and determines the operation required to be performed or the request result based on a determination result.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The described technologies can be applied to both the systems and the radio technologies mentioned above as well as to other systems and radio technologies. The following descriptions describe a new radio (NR) system for example purposes, and NR terms are used in most of the following descriptions, but these technologies can also be applied to an application other than an NR system application, for example, a 6^{th} generation (6G) communication system.

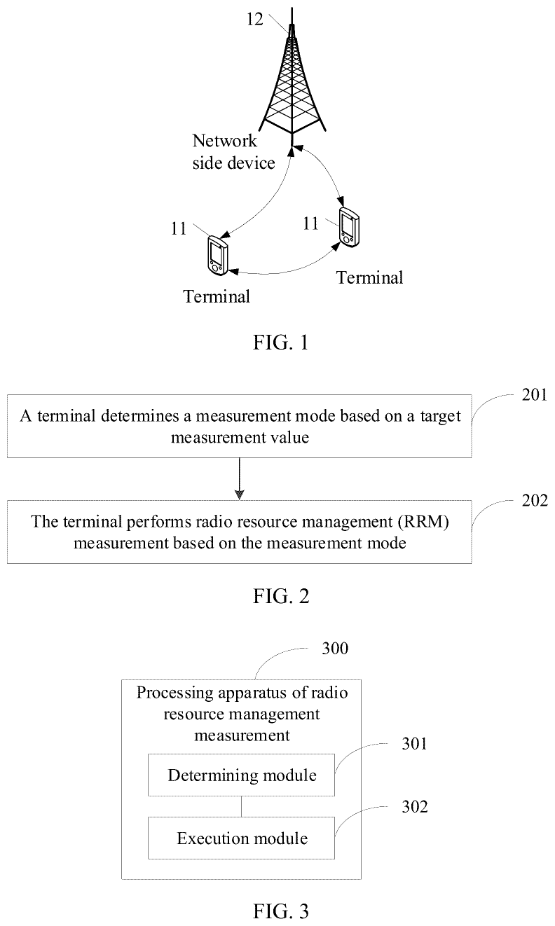

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), smart household (household devices with wireless communication functions, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart bangle, a smart anklet, and the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a radio access network (RAN), a radio access network function, or a radio access network unit. The access network device may include a base station, a wireless local area network (WLAN) access point, a wireless fidelity (Wi-Fi) node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission and reception point (TRP), or another appropriate term in the field. As long as a same technical effect is achieved, the base station is not limited to a specified technical term. It should be noted that, in the embodiments of this application, only a base station in an NR system is used as an example, and a specific type of the base station is not limited.

To facilitate understanding, some content involved in the embodiments of this application is described below.

### I. Low Power Radio.

The low power radio can also be referred to as an LP-WUR or almost zero power wake up radio/receiver (AZP-WUR). A basic working principle of the LP-WUR is: a receive end includes a first module and a second module, the first module is a main communication module (can also be referred to as a main radio/receiver (MR) module), configured to send and receive mobile communication data, and the second module is a low power receiving module (or referred to as a low power wake up receiving module), configured to receive the wake up signal (or referred to as a low power wake up signal). In an energy-saving state, the terminal enables the low power receiving module to monitor the LP-WUS and disables the main communication module. When downlink data arrives, the network side device may send a wake up signal to the terminal. After monitoring the wake up signal by using the low power receiving module, the terminal triggers the main communication module to switch from being disabled to being enabled through a series of determinations. In this case, the low power receiving module enters a disabled state from a working state. The low power wake up receiving module may be enabled continuously or intermittently, and may receive the wake up signal when being enabled.

### II. Low Power Wake Up Signal (LP-WUS).

To reduce receiving activities of the terminal in a standby state, and enable radio frequency (RF) and baseband (also referred to as Modem) modules to be actually disabled, thereby greatly reducing power consumption of communication reception, an almost “zero” power radio may be introduced into the receiving module of the terminal. This almost “zero” power radio does not need complex RF module signal detection (such as amplification, filtering, quantization, and the like) and Modem signal processing, and relies on only passively matching filtering and signal processing with lower power consumption.

On a base station side, the low power wake up signal is triggered on-demand, so that the almost “zero” power radio may be activated to get an activation notice, to trigger a series of processes inside the terminal, for example, enabling modules such as radio frequency transceiver and baseband processing.

These low power wake up signals are usually some simple on-off keying signals. In this way, the radio may learn of a wake up notice through simple energy detection, subsequent possible sequence detection and identification, and other processes. In addition, when the terminal enables the low power wake up radio to receive the low power wake up signal, a main radio module may operate at a lower power consumption level, thereby reducing power consumption by receiving the low power wake up signal.

With reference to the accompanying drawings, a processing method of radio resource management measurement provided in the embodiments of this application is described in detail by using some embodiments and application scenarios thereof.

Refer to FIG. 2, an embodiment of this application provides a processing method of radio resource management measurement. As shown in FIG. 2, the processing method of radio resource management measurement includes the following steps.

Step 201: A terminal determines a measurement mode based on a target measurement value.

Step 202: The terminal performs radio resource management (RRM) measurement based on the measurement mode.

The target measurement value is determined based on at least one of a measurement value obtained by using a low power wake up radio (LP WUR) to perform measurement and a measurement value obtained by using a main radio to perform measurement, and the measurement mode includes any one of the following:
using the LP WUR for RRM measurement, and/or using the MR for RRM measurement based on a first periodicity; and
using the MR for RRM measurement based on a second periodicity, where
a length of the first periodicity is greater than a length of the second periodicity.

In this embodiment of this application, the using the MR for RRM measurement based on a first periodicity can be understood as relaxed RRM measurement, or referred to as relaxed MR measurement, that is, RRM measurement is performed with a relatively large length of the periodicity, so that a quantity of times that the main radio is awakened can be reduced, and therefore, power consumption of RRM measurement is reduced. The using the MR for RRM measurement based on a second periodicity can be understood as non-relaxed RRM measurement, or referred to as non-relaxed MR measurement, that is, RRM measurement is performed with a conventional measurement periodicity, to ensure measurement accuracy.

Optionally, the measurement mode includes using the LP WUR for RRM measurement and using the MR for RRM measurement based on the first periodicity, which can be understood as using the LP WUR for RRM measurement while using the MR for RRM measurement based on the first periodicity, that is, simultaneously using the LP WUR and the MR for RRM measurement, where the LP WUR and the MR may have the same or different measurement periodicities, which is not further limited herein.

It should be understood that there is no need to wake up the main radio when it is determined to use the LP WUR for RRM measurement, thereby minimizing power consumption of RRM measurement. When it is determined to use the MR for RRM measurement based on the first periodicity, the quantity of times that the main radio is awakened can be reduced, and therefore, power consumption of RRM measurement is reduced. When it is determined to use the LP WUR for RRM measurement, and use the MR for RRM measurement based on the first periodicity, power consumption of RRM measurement can be reduced, and in addition, accuracy of RRM measurement can be ensured to a certain extent.

The target measurement value can be understood as a historical measurement value or a value determined based on the historical measurement value, that is, a current measurement mode can be determined based on a historical measurement situation. For example, when it is determined based on the target measurement value that a current channel state is good, the LP WUR may be used for RRM measurement; when it is determined based on the target measurement value that the current channel state is normal, the MR may be used for RRM measurement based on the first periodicity, or the LP WUR is used for RRM measurement while the MR is used for RRM measurement based on the first periodicity; and when it is determined based on the target measurement value that the current channel state is poor, the MR is used for RRM measurement based on the second periodicity.

In this embodiment of this application, a terminal determines a measurement mode based on a target measurement value; and the terminal performs radio resource management (RRM) measurement based on the measurement mode, where the target measurement value is determined based on at least one of a measurement value obtained by using a low power wake up radio (LP WUR) to perform measurement and a measurement value obtained by using a main radio (MR) to perform measurement, and the measurement mode includes any one of the following: using the LP WUR for RRM measurement, and/or using the MR for RRM measurement based on a first periodicity; and using the MR for RRM measurement based on a second periodicity, where a length of the first periodicity is greater than a length of the second periodicity. In this way, based on measurement results of the LP WUR and the MR, the LP WUR and the MR can be flexibly set for RRM measurement, thereby reducing power consumption of RRM measurement.

Optionally, in some embodiments, the target measurement value is determined based on historical RRM measurement. Certainly, in other embodiments, the target measurement value may alternatively be determined based on other measurement. For example, in some embodiments, the target measurement value may be determined based on a result of radio link monitoring, determined based on a result of layer 1 (L1) measurement, or determined based on a measurement result of a beacon signal. For example, the target measurement values may be a reference signal received power (RSRP), a signal-to-noise and interference ratio (SINR), or the like, and may alternatively be a correct rate, an error rate, or the like of beacon measurement.

Optionally, in some embodiments, the target measurement value includes at least one of a first measurement value, a second measurement value, and a third measurement value, where
the first measurement value is a measurement value obtained by using the LP WUR to perform RRM measurement, or a filtered value of N1 measurement values obtained by using the LP WUR to perform RRM measurement; the second measurement value is a measurement value obtained by using the MR to perform RRM measurement, or a filtered value of N2 measurement values obtained by using the MR to perform RRM measurement; and the third measurement value is obtained through calculation based on the first measurement value and the second measurement value, and both N1 and N2 are integers greater than 1.

In this embodiment of this application, the filtering algorithm may be set as required. For example, in some embodiments, the first measurement value and the second measurement value may be obtained through filtering in a manner of arithmetic average filtering, median filtering, or the like. The third measurement value may be obtained in a linear processing manner. For example, the third measurement value may be obtained by multiplying the first measurement value by a first preset coefficient and adding a product of the second measurement result multiplied by a second preset coefficient. Certainly, other calculation methods may also be used to obtain the third measurement value, which is not further limited herein. The first preset coefficient may be the same as or different from the second preset coefficient. In addition, the first preset coefficient and the second preset coefficient may be specified by a protocol or configured by the network side device.

Optionally, in some embodiments, the N1 measurement values and N2 measurement values may be measurement values in a preset time period, for example, a plurality of measurement values in a recent period of time, or measurement values in recent times.

Optionally, in some embodiments, the measurement mode satisfies:
using the LP WUR for RRM measurement in a case that a first trigger condition is met, where the first trigger condition includes at least one of the following:
the first measurement value is greater than or equal to a first threshold; and
the second measurement value is greater than or equal to a second threshold.

In this embodiment of this application, values of the first threshold and the second threshold may be set according to actual requirements, and in some embodiments, the first threshold and the second threshold may be specified by a protocol or indicated by the network side device, which is not further limited herein.

Optionally, in some embodiments, the measurement mode satisfies:
using the MR for RRM measurement in a case that a second trigger condition is met, where the second trigger condition includes at least one of the following:
the first measurement value is less than or equal to a third threshold; and
the second measurement value is less than or equal to a fourth threshold.

In this embodiment of this application, the periodicity in which the MR is used for RRM measurement may be the first periodicity or the second periodicity. For example, in some embodiments, the first periodicity may be used for RRM measurement by default. That is, the using the MR for RRM measurement in a case that a second trigger condition is met includes:
using the MR for RRM measurement based on the first periodicity by default in a case that the second trigger condition is met.

Optionally, in a process of performing RRM measurement based on the first periodicity, the measurement periodicity may be further switched. For example, the using the MR for RRM measurement further includes:
in a case that at least one of the first measurement value, the second measurement value, and the third measurement value is less than or equal to a fifth threshold, switching to using the MR for RRM measurement based on the second periodicity, where
the fifth threshold is less than the third threshold or the fourth threshold.

In this embodiment of this application, in a case that at least one of the first measurement value, the second measurement value, and the third measurement value is less than or equal to a fifth threshold, it indicates that current channel quality is poor, and the using the MR for RRM measurement based on the second periodicity may improve measurement accuracy and improve reliability of communication.

It should be noted that, in a process of performing RRM measurement based on the first periodicity and using the WUR for RRM measurement, in a case that the first measurement value, the second measurement value, or the third measurement value is less than or equal to the fifth threshold, it is also possible to switch to using the MR for RRM measurement based on the second periodicity.

Optionally, in some embodiments, the measurement mode satisfies:
the measurement mode is using the LP WUR for RRM measurement and using the MR for RRM measurement based on the first periodicity in a case that a third trigger condition is met, where the third trigger condition includes at least one of the following:
at least one of the first measurement value, the second measurement value, and the third measurement value is less than or equal to a sixth threshold; and
at least one of the first measurement value, the second measurement value, and the third measurement value is greater than or equal to a seventh threshold.

Optionally, in some embodiments, a trigger condition of using the MR for RRM measurement further includes:
a low power wake up signal is received by the terminal, and the low power wake up signal indicates the terminal to receive a paging physical downlink control channel (PDCCH).

In this embodiment of this application, the low power wake up signal may be a signal indicating at least one group of terminals to receive the paging PDCCH.

Optionally, in some embodiments, the RRM measurement includes at least one of the following: serving cell measurement, resident cell measurement, intra-frequency measurement, and inter-frequency measurement.

Optionally, a measurement object of the RRM measurement includes at least one of a synchronization signal and PBCH block (SSB), a channel state information reference signal (CSI-RS), a beacon signal, a low power synchronization signal (LP-SS), and a low power wake up signal (LP-WUS).

A measurement object using the MR for measurement may include SSB or CSI-RS;
and a measurement object using the WUR for measurement includes Beacon, LP-SS, or LP-WUS.

In this embodiment of this application, the measurement object can be understood as or replaced with a measurement resource.

Optionally, the beacon signal may include at least one of a sequence signal, a cell ID, time information, and partial system information; the LP-SS may include a synchronization signal sequence; and the LP-WUS may include at least one of a sequence signal and wake up information.

Optionally, in some embodiments, a modulation mode of the measurement object is on-off keying (OOK), amplitude shift keying (ASK), or frequency shift keying (FSK).

To better understand this application, some examples are used for detailed description below.

In some embodiments, modes in which the terminal performs RRM measurement include:
WUR measurement;
relaxed MR measurement; and
non-relaxed MR measurement.

Optionally, WUR measurement may also be enabled in the mode of relaxed MR measurement. Serving cells, resident cells, carriers, or signals of WUR measurement and MR measurement may be the same or different.

Cells and frequencies of WUR measurement and MR measurement can be different. For example, the WUR is used for measuring only F1 frequency, while the MR may be used for measuring F1 frequency and/or F2 frequency. MR measurement may be relaxed measurement or non-relaxed measurement. A cell in which an MR measurement signal is sent may be the same as or different from a cell in which a WUR measurement signal is sent, and a frequency at which the MR measurement signal is sent may be the same as or different from a frequency at which the WUR measurement signal is sent.

For example, a working mode may be as follows.
(1) The WUR is used for measuring F1, and the MR is used for measuring F2. For example, the F1 frequency is a frequency of a signal that is used for WUR measurement and that is sent by a terminal resident cell, and F2 is a frequency of inter-frequency measurement. In this case, measurement of the resident cell/frequency is completely completed by the WUR. Inter-frequency measurement is completed by the MR, which may reduce the use of the MR for RRM measurement and reduce power consumption of the terminal.
(2) The WUR is used for measuring F1, and the MR is used for measuring F1 and F2. In this case, the WUR is used for measurement of only the resident/serving cell, and the MR is used for intra-frequency measurement or inter-frequency measurement of the resident cell. The MR measurement may be in a relaxed or non-relaxed mode, which is determined based on accuracy and power consumption of the measurement.

Optionally, the measurement object of RRM measurement may be at least one of the following:
a measurement object using the MR for measurement may include SSB or CSI-RS; and
a measurement object using the WUR for measurement includes Beacon, LP-SS, or LP-WUS.

Optionally, in this embodiment of this application, MR measurement can be equivalent to receiving SSB or CSI-RS for RRM measurement; and WUR measurement can be equivalent to receiving Beacon, LP-SS, or LP-WUS for RRM measurement.

The modulation mode of the measurement object is on-off keying (OOK), amplitude shift keying (ASK), or frequency shift keying (FSK). An RRM measurement value may include RSRP, RSRQ, SINR, or the like.

In some embodiments, to enable the terminal to work with lower power consumption, an RRM measurement behavior of the terminal needs to be optimized and adjusted. That is, a corresponding radio is used for RRM measurement based on a channel condition, and times of using the MR for RRM measurement are reduced as much as possible.

Because the low power radio has worse coverage performance than that of the main radio, and has lower measurement accuracy, it is usually considered to use the WUR for measurement in a case of good channel quality, to reduce measurement power consumption. In a case of poor channel quality, the MR may be used for RRM measurement, to improve measurement accuracy.

Optionally, in a case that the terminal uses the WUR for measurement, if the first measurement value is greater than or equal to the first threshold, the WUR is continued to be used for measurement; and if the first measurement value is less than or equal to the third threshold, the MR is used for RRM measurement.

Optionally, in a case that the terminal uses the MR for measurement, if the second measurement value is greater than or equal to the second threshold, the WUR is used for measurement and/or exit MR measurement; and if the second measurement value is less than or equal to the fourth threshold, the MR is continued to be used for measurement.

Optionally, the first measurement value is determined based on a measurement value obtained through WUR measurement, and may include a value of single measurement, or a filtered value of measurement values obtained through a plurality of times of WUR measurement; and the second measurement value is determined based on a measurement value obtained through MR measurement, and may include a value of single measurement, or a filtered value of measurement values obtained through a plurality of times of MR measurement. The first threshold and the third threshold are used for comparison with the first measurement value, and the second threshold and the fourth threshold are used for comparison with the second measurement value; and a radio that performs measurement is determined based on comparison results.

Optionally, the using the MR for RRM measurement includes relaxed RRM measurement or non-relaxed RRM measurement; and a first periodicity of relaxed RRM measurement is greater than a second periodicity of non-relaxed RRM measurement. Non-relaxed RRM measurement can be understood as conventional RRM measurement.

Optionally, in some embodiments, the terminal enables relaxed RRM measurement by default when the condition of using the MR for RRM measurement is met; and then it is determined based on the measurement value whether to enable non-relaxed RRM measurement.

In some embodiments, the WUR may be used for RRM measurement while the MR is used for relaxed RRM measurement.

Optionally, because accuracy of WUR measurement alone is low, one working mode is: the terminal uses the WUR for RRM measurement, and in this case, the MR is enabled for RRM measurement. In RRM measurement of the MR, RRM measurement is performed with a relaxed periodicity.

Optionally, both the WUR and the MR may be enabled for RRM measurement in a case that the following third trigger condition is met:
at least one of the first measurement value, the second measurement value, and the third measurement value is less than or equal to a sixth threshold; and
at least one of the first measurement value, the second measurement value, and the third measurement value is greater than or equal to a seventh threshold.

Optionally, the third measurement value is obtained through calculation based on the first measurement value and the second measurement value.

In this embodiment of this application, the terminal may determine, based on only a measurement value of WUR, whether to enable RRM measurement of both the MR and the WUR. This method is suitable for an RRM measurement mode in which the terminal is based on only the WUR, and an RRM measurement mode in which the terminal is based on both the WUR and the MR enabled;
the terminal may determine, based on only a measurement value of MR, whether to enable RRM measurement of both the MR and the WUR. This method is suitable for a non-relaxed RRM measurement mode in which the terminal is based on only the WUR, and an RRM measurement mode in which the terminal is based on both the WUR and the MR enabled; or
in the RRM measurement mode in which both the WUR and the MR are enabled, the terminal determines, based on the third measurement value, whether to maintain a state in which both the WUR measurement and the MR measurement are enabled.

Optionally, the sixth threshold and the seventh threshold may be thresholds configured by the network side device, or thresholds obtained by the terminal through calculation based on the first threshold. For example, the sixth threshold and the seventh threshold are obtained by multiplying the first threshold by a corresponding preset coefficient, or the sixth threshold and the seventh threshold are obtained after the first threshold is increased or decreased by a preset value.

Optionally, the third trigger condition may indicate that accuracy and reliability of the measurement value of the channel in this case are between trustworthy and untrustworthy, or the measurement value of the channel shows that the link quality in this case is within a coverage area of the WUR but close to an edge of coverage. The MR may need to be enabled periodically to assist RRM measurement. Because power consumption of RRM measurement by using the MR is large, measurement should be performed in a longer length of the periodicity, that is, a relaxed periodicity, to control overall power consumption of the terminal.

Optionally, when the terminal is in the relaxed RRM measurement mode, it is switched to non-relaxed RRM measurement when the following condition is met: at least one of the first measurement value, the second measurement value, and the third measurement value is less than or equal to a fifth threshold.

Optionally, the terminal may determine, based on at least one of the first measurement value, the second measurement value, and the third measurement value, whether the channel condition is deteriorated, to use the MR for conventional RRM measurement, thereby ensuring accurate measurement and rapid cell handover or reselection.

In this embodiment of this application, at least one of the first measurement value, the second measurement value, and the third measurement value is less than or equal to a fifth threshold, which can be understood as that the channel quality is already poor in this case, and it is no longer possible to use a relaxed RRM measurement manner of the MR, or an RRM measurement manner combined with the WUR. A non-relaxed RRM measurement manner should be used in this case. Because the non-relaxed RRM measurement manner is already accurate, the terminal may stop measurement of the WUR in this case.

It should be noted that the fact that the terminal enables both the WUR and the MR for RRM measurement does not mean that the two measurement behaviors required by the terminal must occur at the same time, the measurement resources are at the same time, or the time resources overlap. It only indicates that the terminal enables two radios to obtain the RRM measurement values.

In some embodiments, when a WUS wake up manner includes a plurality of terminals, the relaxed MR is used for RRM measurement.

Optionally, the WUS may be used for waking up a plurality of groups of terminals for subsequent paging PDCCH receiving. Because an indicated mode is not for a specific terminal, there is a false wake up probability. However, after receiving the indication information, the terminal needs to receive a synchronization signal to synchronize the main radio, to prepare for receiving of paging or sending of the PRACH.

Because the PDCCH receiving is a behavior on the MR, the terminal may use the MR for RRM measurement by the way, including performing RRM measurement in a relaxed or non-relaxed manner. If subsequent paging information does not include a paging indication of the terminal, the terminal may disable the MR. Before this, the terminal determines, based on a switching condition for enabling the MR for measurement, a radio for RRM measurement.

It should be noted that using the LP WUR for RRM measurement can be understood as or replaced with performing WUR measurement, performing WUR measurement can be equivalent to receiving a beacon signal, LP-SS, or LP-WUS for RRM measurement, and receiving a beacon signal, LP-SS, or LP-WUS for RRM measurement can be understood as or replaced with performing beacon signal measurement, performing LP-SS measurement, or performing LP-WUS measurement. Similarly, using the MR for RRM measurement can be understood as or replaced with performing MR measurement, performing MR measurement can be equivalent to receiving SSB or CSI-RS for RRM measurement, and receiving SSB or CSI-RS for RRM measurement can be understood as or replaced with performing SSB measurement or performing CSI-RS measurement. That is, the processing method of radio resource management measurement in this application can be understood as including the following steps:
determining, by a terminal, a target measurement mode based on a target measurement value; and
performing, by the terminal, radio resource management (RRM) measurement based on the target measurement mode, where
the target measurement value is determined based on at least one of a measurement value obtained by a first measurement object and a measurement value obtained by a second measurement object, and the target measurement mode includes any one of the following:
measuring the first measurement object, and/or measuring the second measurement object based on a first periodicity; and
measuring the second measurement object based on a second periodicity, where
a length of the first periodicity is greater than a length of the second periodicity.

Optionally, the target measurement value includes at least one of a first measurement value, a second measurement value, and a third measurement value, where
the first measurement value is a measurement value obtained by measuring the first measurement object, or a filtered value of N1 measurement values obtained by measuring the first measurement object; the second measurement value is a measurement value obtained by performing RRM measurement based on the second measurement object, or a filtered value of N2 measurement values obtained by performing RRM measurement based on the second measurement object; and the third measurement value is obtained through calculation based on the first measurement value and the second measurement value, and both N1 and N2 are integers greater than 1.

Optionally, the target measurement mode satisfies:
measuring the first measurement object in a case that a first trigger condition is met, where the first trigger condition includes at least one of the following:
the first measurement value is greater than or equal to a first threshold; and
the second measurement value is greater than or equal to a second threshold.

Optionally, the target measurement mode satisfies:
measuring the second measurement object in a case that a second trigger condition is met, where the second trigger condition includes at least one of the following:
the first measurement value is less than or equal to a third threshold; and
the second measurement value is less than or equal to a fourth threshold.

Optionally, the measuring the second measurement object in a case that a second trigger condition is met includes:
measuring the second measurement object based on the first periodicity by default in a case that the second trigger condition is met.

Optionally, the measuring the second measurement object further includes:
in a case that at least one of the first measurement value, the second measurement value, and the third measurement value is less than or equal to a fifth threshold, switching to measuring the second measurement object based on the second periodicity, where
the fifth threshold is less than the third threshold or the fourth threshold.

Optionally, the measurement mode satisfies:
in a case that the third trigger condition is met, the measurement mode is measuring the first measurement object and measuring the second measurement object, where the third trigger condition includes at least one of the following:
at least one of the first measurement value, the second measurement value, and the third measurement value is less than or equal to a sixth threshold; and
at least one of the first measurement value, the second measurement value, and the third measurement value is greater than or equal to a seventh threshold.

Optionally, the target measurement value is determined based on historical RRM measurement.

Optionally, the trigger condition for measuring the second measurement object further includes:
a low power wake up signal is received by the terminal, and the low power wake up signal indicates the terminal to receive a paging physical downlink control channel (PDCCH).

Optionally, the low power wake up signal indicates at least one group of terminals to receive the paging PDCCH.

Optionally, the RRM measurement includes at least one of the following: serving cell measurement, resident cell measurement, intra-frequency measurement, and inter-frequency measurement.

Optionally, the first measurement object includes at least one of a beacon signal, a low power synchronization signal (LP-SS), and a low power wake up signal (LP-WUS).

Optionally, the second measurement object includes at least one of a synchronization signal and PBCH block (SSB) and a channel state information reference signal (CSI-RS).

Optionally, a modulation mode of at least one of the first measurement object and the second measurement object is on-off keying (OOK), amplitude shift keying (ASK), or frequency shift keying (FSK).

Optionally, the measuring the first measurement object includes measuring the first measurement object by using a low power wake up radio (LP-WUR).

Optionally, the measuring the second measurement object includes measuring the second measurement object by using a main radio (MR).

The processing method of radio resource management measurement provided in this embodiment of this application may be executed by a processing apparatus of radio resource management measurement. In this embodiment of this application, that the processing apparatus of radio resource management measurement performs the processing method of radio resource management measurement is used as an example to describe the processing apparatus of radio resource management measurement provided in this embodiment of this application.

Refer to FIG. 3, an embodiment of this application further provides a processing apparatus of radio resource management measurement. As shown in FIG. 3, the processing apparatus 300 of radio resource management measurement includes:
a determining module 301, configured to determine a measurement mode based on a target measurement value; and
an execution module 302, configured to perform radio resource management (RRM) measurement based on the measurement mode, where
the target measurement value is determined based on at least one of a measurement value obtained by using a low power wake up radio (LP WUR) to perform measurement and a measurement value obtained by using a main radio (MR) to perform measurement, and the measurement mode includes any one of the following:
using the LP WUR for RRM measurement, and/or using the MR for RRM measurement based on a first periodicity; and
using the MR for RRM measurement based on a second periodicity, where
a length of the first periodicity is greater than a length of the second periodicity.

Optionally, the target measurement value includes at least one of a first measurement value, a second measurement value, and a third measurement value, where
the first measurement value is a measurement value obtained by using the LP WUR to perform RRM measurement, or a filtered value of N1 measurement values obtained by using the LP WUR to perform RRM measurement; the second measurement value is a measurement value obtained by using the MR to perform RRM measurement, or a filtered value of N2 measurement values obtained by using the MR to perform RRM measurement; and the third measurement value is obtained through calculation based on the first measurement value and the second measurement value, and both N1 and N2 are integers greater than 1.

Optionally, the measurement mode satisfies:
using the LP WUR for RRM measurement in a case that a first trigger condition is met, where the first trigger condition includes at least one of the following:
the first measurement value is greater than or equal to a first threshold; and
the second measurement value is greater than or equal to a second threshold.

Optionally, the measurement mode satisfies:
using the MR for RRM measurement in a case that a second trigger condition is met, where the second trigger condition includes at least one of the following:
the first measurement value is less than or equal to a third threshold; and
the second measurement value is less than or equal to a fourth threshold.

Optionally, the using the MR for RRM measurement in a case that a second trigger condition is met includes:
using the MR for RRM measurement based on the first periodicity by default in a case that the second trigger condition is met.

Optionally, the using the MR for RRM measurement further includes:
in a case that at least one of the first measurement value, the second measurement value, and the third measurement value is less than or equal to a fifth threshold, switching to using the MR for RRM measurement based on the second periodicity, where
the fifth threshold is less than the third threshold or the fourth threshold.

Optionally, the measurement mode satisfies:
the measurement mode is using the LP WUR for RRM measurement and using the MR for RRM measurement based on the first periodicity in a case that a third trigger condition is met, where the third trigger condition includes at least one of the following:
at least one of the first measurement value, the second measurement value, and the third measurement value is less than or equal to a sixth threshold; and
at least one of the first measurement value, the second measurement value, and the third measurement value is greater than or equal to a seventh threshold.

Optionally, the target measurement value is determined based on historical RRM measurement.

Optionally, a trigger condition of using the MR for RRM measurement further includes:
a low power wake up signal is received by the terminal, and the low power wake up signal indicates the terminal to receive a paging physical downlink control channel (PDCCH).

Optionally, the low power wake up signal indicates at least one group of terminals to receive the paging PDCCH.

Optionally, the RRM measurement includes at least one of the following: serving cell measurement, resident cell measurement, intra-frequency measurement, and inter-frequency measurement.

Optionally, a measurement object of the RRM measurement includes at least one of a beacon signal, a low power synchronization signal (LP-SS), and a low power wake up signal (LP-WUS).

Optionally, a modulation mode of the measurement object is on-off keying (OOK), amplitude shift keying (ASK), or frequency shift keying (FSK).

The processing apparatus of radio resource management measurement in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a network attached storage (NAS), and the like. This is not specifically limited in this embodiment of this application.

The processing apparatus of radio resource management measurement provided in this embodiment of this application can implement the processes implemented in the method embodiment in FIG. 2, and a same technical effect can be achieved. To avoid repetition, details are not described herein again.

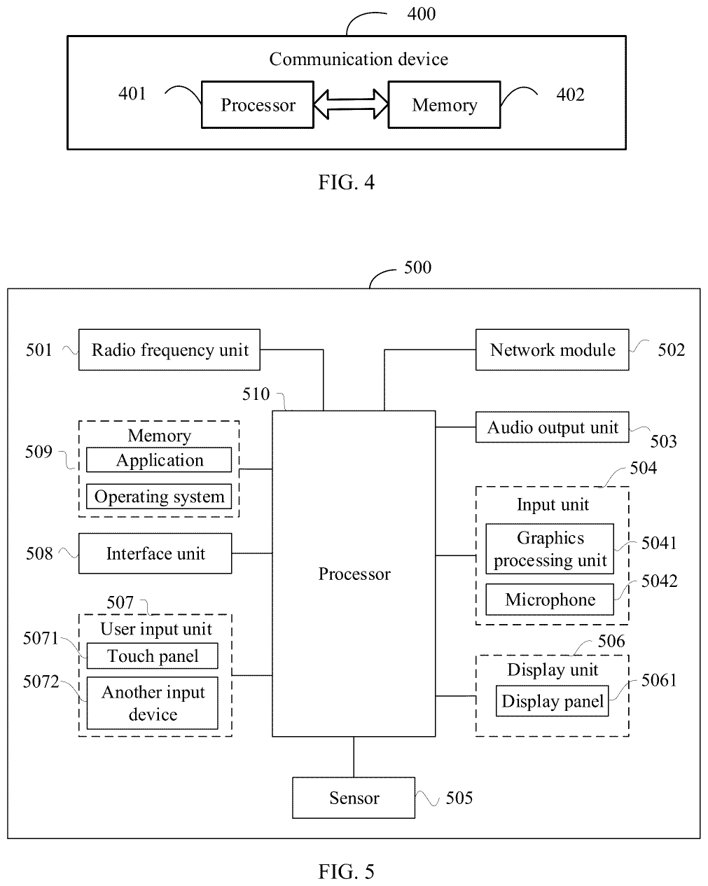

Optionally, as shown in FIG. 4, an embodiment of this application further provides a communication device 400, including a processor 401 and a memory 402, and the memory 402 stores a program or an instruction that can be run on the processor 401. When the program or the instruction is executed by the processor 401, the steps of the embodiment of the processing apparatus of radio resource management measurement are implemented, and a same technical effect can be achieved. To avoid repetition, details are not described herein again.

An embodiment of this application further provides a terminal, including a processor and a communication interface. The processor is configured to determine a measurement mode based on a target measurement value; and the communication interface is configured to perform radio resource management (RRM) measurement based on the measurement mode, where the target measurement value is determined based on at least one of a measurement value obtained by using a low power wake up radio (LP WUR) to perform measurement and a measurement value obtained by using a main radio (MR) to perform measurement, and the measurement mode includes any one of the following: using the LP WUR for RRM measurement, and/or using the MR for RRM measurement based on a first periodicity; and using the MR for RRM measurement based on a second periodicity, where a length of the first periodicity is greater than a length of the second periodicity. The terminal embodiment is corresponding to the terminal side method embodiment, each implementation process and implementation of the method embodiment may be applied to the terminal embodiment, and a same technical effect can be achieved. Specifically, FIG. 5 is a schematic diagram of a hardware structure of a terminal according to an embodiment of this application.

The terminal 500 includes but is not limited to: at least some of the following components: a radio frequency unit 501, a network module 502, an audio output unit 503, an input unit 504, a sensor 505, a display unit 506, a user input unit 507, an interface unit 508, a memory 509, and a processor 510.

A person skilled in the art may understand that the terminal 500 may further include a power supply (such as a battery) that supplies power to each component. The power supply may be logically connected to the processor 510 through a power management system, to implement functions such as charging and discharging management, and power consumption management by using the power management system. The terminal structure shown in FIG. 5 constitutes no limitation on the terminal, and the terminal may include more or fewer components than those shown in the figure, or combine some components, or have different component arrangements. Details are not described herein again.

It should be understood that, in this embodiment of this application, the input unit 504 may include a graphics processing unit (GPU) 5041 and a microphone 5042, and the graphics processing unit 5041 processes image data of a still picture or a video obtained by an image capture apparatus (such as a camera) in a video capture mode or an image capture mode. The display unit 506 may include a display panel 5061, and the display panel 5061 may be configured in a form of a liquid crystal display, an organic light-emitting diode, or the like. The user input unit 507 includes at least one of a touch panel 5071 and another input device 5072. The touch panel 5071 is also referred to as a touchscreen. The touch panel 5071 may include two parts: a touch detection apparatus and a touch controller. The another input device 5072 may include but is not limited to a physical keyboard, a functional button (such as a volume control button or a power on/off button), a trackball, a mouse, and a joystick. Details are not described herein again.

In this embodiment of this application, after receiving downlink data from a network side device, the radio frequency unit 501 may transmit the downlink data to the processor 510 for processing. In addition, the radio frequency unit 501 may send uplink data to the network side device. Generally, the radio frequency unit 501 includes but is not limited to an antenna, an amplifier, a transceiver, a coupler, a low noise amplifier, a duplexer, and the like.

The memory 509 may be configured to store a software program or an instruction and various data. The memory 509 may mainly include a first storage area for storing a program or instructions and a second storage area for storing data. The first storage area may store an operating system, and an application or an instruction required by at least one function (for example, a sound playing function or an image playing function). In addition, the memory 509 may be a volatile memory or a non-volatile memory, or the memory 509 may include a volatile memory and a non-volatile memory. The non-volatile memory may be a read-only memory (Read-Only Memory, ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 509 in this embodiment of this application includes but is not limited to these memories and any memory of another proper type.

The processor 510 may include one or more processing units. Optionally, an application processor and a modem processor are integrated into the processor 510. The application processor mainly processes an operating system, a user interface, an application, or the like. The modem processor mainly processes a wireless communication signal, for example, a baseband processor. It may be understood that, alternatively, the modem processor may not be integrated into the processor 510.

The processor 510 is configured to determine a measurement mode based on a target measurement value; and
the radio frequency unit 501 is configured to perform radio resource management (RRM) measurement based on the measurement mode, where
the target measurement value is determined based on at least one of a measurement value obtained by using a low power wake up radio (LP WUR) to perform measurement and a measurement value obtained by using a main radio (MR) to perform measurement, and the measurement mode includes any one of the following:
using the LP WUR for RRM measurement, and/or using the MR for RRM measurement based on a first periodicity; and
using the MR for RRM measurement based on a second periodicity, where
a length of the first periodicity is greater than a length of the second periodicity.

An embodiment of this application further provides a readable storage medium. The readable storage medium stores a program or an instruction. When the program or the instruction is executed by a processor, the processes of the embodiment of the processing method of radio resource management measurement are implemented, and a same technical effect can be achieved. To avoid repetition, details are not described herein again.

The processor is a processor in the terminal in the foregoing embodiments. The readable storage medium includes a computer-readable storage medium, such as a computer read-only memory (ROM), a random access memory (RAM), a magnetic disk, or an optical disc.

An embodiment of this application further provides a chip. The chip includes a processor and a communication interface, and the communication interface is coupled to the processor. The processor is configured to run a program or an instruction, to implement various processes of the embodiment of the processing method of radio resource management measurement, and a same technical effect can be achieved. To avoid repetition, details are not described herein again.

It should be understood that the chip mentioned in this embodiment of this application may also be referred to as a system-level chip, a system chip, a chip system, an on-chip system chip, or the like.

An embodiment of this application further provides a computer program/program product. The computer program/program product is stored in a storage medium, the computer program/program product is executed by at least one processor to implement the processes of the embodiment of the processing method of radio resource management measurement, and a same technical effect can be achieved. To avoid repetition, details are not described herein again.

It should be noted that in this specification, the term “include”, “comprise”, or any other variant is intended to cover non-exclusive inclusion, so that a process, method, article, or apparatus that includes a series of elements includes not only those elements but also other elements that are not explicitly listed, or includes elements inherent to such a process, method, article, or apparatus. In the absence of more restrictions, an element defined by the statement “including a . . . ” does not preclude the presence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (such as a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A processing method of radio resource management measurement, comprising:
determining, by a terminal, a measurement mode based on a target measurement value; and
performing, by the terminal, radio resource management (RRM) measurement based on the measurement mode, wherein
the target measurement value is determined based on at least one of a measurement value obtained by using a low power wake up radio (LP WUR) to perform measurement or a measurement value obtained by using a main radio (MR) to perform measurement, and the measurement mode comprises any one of the following:
using the LP WUR for RRM measurement, and/or using the MR for RRM measurement based on a first periodicity; or
using the MR for RRM measurement based on a second periodicity, wherein
a length of the first periodicity is greater than a length of the second periodicity.

2. The method according to claim 1, wherein the target measurement value comprises at least one of a first measurement value or a second measurement value, wherein
the first measurement value is a filtered value of N1 measurement values obtained by using the LP WUR to perform RRM measurement; and the second measurement value is a filtered value of N2 measurement values obtained by using the MR to perform RRM measurement; and
both N1 and N2 are integers greater than 1.

3. The method according to claim 2, wherein the measurement mode satisfies:
using the LP WUR for RRM measurement in a case that a first trigger condition is met, wherein the first trigger condition comprises at least one of the following:
the first measurement value is greater than or equal to a first threshold; or
the second measurement value is greater than or equal to a second threshold.

4. The method according to claim 2, wherein the measurement mode satisfies:
using the MR for RRM measurement in a case that a second trigger condition is met, wherein the second trigger condition comprises at least one of the following:
the first measurement value is less than or equal to a third threshold; or
the second measurement value is less than or equal to a fourth threshold.

5. The method according to claim 4, wherein the using the MR for RRM measurement in a case that a second trigger condition is met comprises:
using the MR for RRM measurement based on the first periodicity by default in a case that the second trigger condition is met.

6. The method according to claim 5, wherein the using the MR for RRM measurement further comprises:
in a case that the first measurement value is less than or equal to a fifth threshold, switching to using the MR for RRM measurement based on the second periodicity, wherein
the fifth threshold is less than the third threshold or the fourth threshold.

7. The method according to claim 1, wherein a measurement object of the RRM measurement comprises at least one of a synchronization signal and PBCH block (SSB), a channel state information reference signal (CSI-RS), a low power synchronization signal (LP-SS), or a low power wake up signal (LP-WUS).

8. The method according to claim 7, wherein a modulation mode of the measurement object is on-off keying (OOK), amplitude shift keying (ASK), or frequency shift keying (FSK).

9. A terminal, comprising a processor and a memory, wherein the memory stores a program or an instruction that can be run on the processor, wherein the program or the instruction, when executed by the processor, causes the terminal to perform:
determining a measurement mode based on a target measurement value; and
performing radio resource management (RRM) measurement based on the measurement mode, wherein
the target measurement value is determined based on at least one of a measurement value obtained by using a low power wake up radio (LP WUR) to perform measurement or a measurement value obtained by using a main radio (MR) to perform measurement, and the measurement mode comprises any one of the following:
using the LP WUR for RRM measurement, and/or using the MR for RRM measurement based on a first periodicity; or
using the MR for RRM measurement based on a second periodicity, wherein
a length of the first periodicity is greater than a length of the second periodicity.

10. The terminal according to claim 9, wherein the target measurement value comprises at least one of a first measurement value or a second measurement value, wherein
the first measurement value is a filtered value of N1 measurement values obtained by using the LP WUR to perform RRM measurement; and the second measurement value is a filtered value of N2 measurement values obtained by using the MR to perform RRM measurement; and
both N1 and N2 are integers greater than 1.

11. The terminal according to claim 10, wherein the measurement mode satisfies:
using the LP WUR for RRM measurement in a case that a first trigger condition is met, wherein the first trigger condition comprises at least one of the following:
the first measurement value is greater than or equal to a first threshold; or
the second measurement value is greater than or equal to a second threshold.

12. The terminal according to claim 10, wherein the measurement mode satisfies:
using the MR for RRM measurement in a case that a second trigger condition is met, wherein the second trigger condition comprises at least one of the following:
the first measurement value is less than or equal to a third threshold; or
the second measurement value is less than or equal to a fourth threshold.

13. The terminal according to claim 12, wherein the using the MR for RRM measurement in a case that a second trigger condition is met comprises:
using the MR for RRM measurement based on the first periodicity by default in a case that the second trigger condition is met.

14. The terminal according to claim 13, wherein the using the MR for RRM measurement further comprises:
in a case that the first measurement value is less than or equal to a fifth threshold, switching to using the MR for RRM measurement based on the second periodicity, wherein
the fifth threshold is less than the third threshold or the fourth threshold.

15. The terminal according to claim 9, wherein a measurement object of the RRM measurement comprises at least one of a synchronization signal and PBCH block (SSB), a channel state information reference signal (CSI-RS), a low power synchronization signal (LP-SS), or a low power wake up signal (LP-WUS).

16. The terminal according to claim 15, wherein a modulation mode of the measurement object is on-off keying (OOK), amplitude shift keying (ASK), or frequency shift keying (FSK).

17. A non-transitory readable storage medium, wherein the non-transitory readable storage medium stores a program or an instruction, wherein the program or the instruction, when executed by a processor of a terminal, causes the terminal to perform:
determining a measurement mode based on a target measurement value; and
performing radio resource management (RRM) measurement based on the measurement mode, wherein
the target measurement value is determined based on at least one of a measurement value obtained by using a low power wake up radio (LP WUR) to perform measurement or a measurement value obtained by using a main radio (MR) to perform measurement, and the measurement mode comprises any one of the following:
using the LP WUR for RRM measurement, and/or using the MR for RRM measurement based on a first periodicity; or
using the MR for RRM measurement based on a second periodicity, wherein
a length of the first periodicity is greater than a length of the second periodicity.

18. The non-transitory readable storage medium according to claim 17, wherein the target measurement value comprises at least one of a first measurement value or a second measurement value, wherein
the first measurement value is a filtered value of N1 measurement values obtained by using the LP WUR to perform RRM measurement; and the second measurement value is a filtered value of N2 measurement values obtained by using the MR to perform RRM measurement; and both N1 and N2 are integers greater than 1.

19. The non-transitory readable storage medium according to claim 18, wherein the measurement mode satisfies:
using the LP WUR for RRM measurement in a case that a first trigger condition is met, wherein the first trigger condition comprises at least one of the following:
the first measurement value is greater than or equal to a first threshold; or
the second measurement value is greater than or equal to a second threshold.

20. The non-transitory readable storage medium according to claim 18, wherein the measurement mode satisfies:
using the MR for RRM measurement in a case that a second trigger condition is met, wherein the second trigger condition comprises at least one of the following:
the first measurement value is less than or equal to a third threshold; or
the second measurement value is less than or equal to a fourth threshold.
